(19) United States
(12) Patent Application Publication
(10) Pub. No.: US 2026/0363464 A1
(43) Pub. Date: Nov. 19, 2026

(54) CAVITY SIZE IDENTIFICATION IN PERMANENTLY SEALED CASES

(71) Applicant: DYNAMICS INC., Cheswick, PA (US)

(72) Inventors: Jeffrey David Mullen, Glenshaw, PA (US); David J. Malarik, Worthington, PA (US); Sean Shawgo, Jeanette, PA (US)

(21) Appl. No.: 19/676,757

(22) Filed: May 13, 2026

Related U.S. Application Data
(60) Provisional application No. 63/805,269, filed on May 13, 2025.

(51) Int. Cl. A47G 1/12; G06T 7/60

(52) U.S. Cl. CPC A47G 1/12; G06T 7/60

(57) ABSTRACT

Cavity identification in sealed cases is disclosed. Cases to store and protect collectibles are disclosed in which a front portion and a back portion may be mated to form a collectible case. The front portions may be designed for a given set of height and width dimensions that may encompass a variety of different cases. The back portions may be designed for the same height and width but may provide variations in depth such that different cavity sizes may be provided for variations in thickness in a given collectible. The front portion may include numerals indicative of the height and width while the back portion may include the same numerals as well as a third numeral indicative of depth. When the case is assembled properly, the height and width numerals should align when viewed from the front.

### BACKGROUND OF THE INVENTION

This invention relates to protective cases for collectibles.

Collectibles such as sports cards, genre game playing cards (such as cards that identify an individual character or different styles of such character in a game), or any variety of cards, comic books, magazines, three-dimensional objects (including, for example, sports jerseys, baseballs, golf balls, hockey pucks, three-dimensional versions of animated characters), etc. are experiencing an ever increasing interest throughout the collectible community.

Many collectors have taken to enclosing such collectibles in “permanent” encasements in order to protect the collectibles. This often happens after such collectibles have been graded by a grading authority at least for the purpose of maintaining the collectible in the condition it was at the time of grading. Problems, however, have occurred over time particularly when the encasement is not specifically designed for the product being encapsulated. In situations such as that, the collectible may move over time and may become damaged as a result of that movement. In addition, the encasement makes inventorying and keeping track of the collectibles increasingly difficult as the size of a collection grows or, from a commercial prospective, as the number of the stored collectibles grows based on an ever increasing number of customers storing their collectibles with third parties as a way to protect the collectibles from being damaged in the home and as a way to make the collectibles more available for trading and sales to other collectors.

### SUMMARY OF THE INVENTION

Protective encasements are disclosed that are formed from substantially two components, a front component and a rear component. In the present disclosure, the front component may be used with a variety of different back components provided the front and back components have the same height and width dimensions. The different back components, however, are designed to have a varying thickness to accommodate a variety of different collectibles that might otherwise be similar.

In some instances, for example, a collectible might be a common sports card of a star athlete such as Babe Ruth. In other instances, the same collectible might include a piece of game-worn clothing that would likely greatly increase the value of that collectible, but also increase the thickness that must be stored in the encapsulated enclosure. To accommodate the increase in thickness, a different back component would be mated with the common front component where the different back component is sized to accommodate the thicker collectible.

The cases disclosed herein may include multiple cavities within the case, such as, for example, a cavity for a placard that might describe the enclosed collectible. In addition, the placard might include a QR code or other scannable mark that could be unique that might be used to obtain further details about the specific collectible in addition to potentially including a grading and/or the grader who performed the grading. The placard also might include a general serial number that identifies the collectible and/or a more specific serial number that could identify the uniqueness of this specific collectible in that it includes a portion of game-worn clothing. The serial number also might include one portion that identifies the general nature of the collectible (e.g., a Babe Ruth 1929 common card) while another portion identifies the specific nature of the game-worn clothing card.

The front portion of the encasement may include a number of identifiable items such as a mark identifying the company doing the encapsulation and/or grading, as well as notations indicative of the height and width dimensions of the case. As noted above, the front portion may be sealed together with a variety of back portions depending on the desired depth of the cavity between the front and back portions.

The back portion of the encasement may include the same identifiable items such as the mark and the height and width of the case, which should be located in the same location on the back portion as they are located on the front portion. In this manner, the numbers would be easily readable and/or discernable to a person or camera viewing the numbers from the front. In addition to the height and width of the case, however, the back portion could also include an additional number that represents the depth of the cavity within the encapsulation.

The numbers could be scanned and read by a camera or other device to assist in automatic processing of the cases. For example, by viewing the height and width dimensions of an assembled case, it would be readily apparent to a person or an automated processing system that includes, for example cameras, that the numbers either match between the front portion and the back portion, or they don’t and that an error in encapsulation/assembly have occurred.

By way of example, a processing system may view a particular encapsulated collectible to have three numbers which would confirm that the collectible was successfully encapsulated provided the numbers could be clearly read which would confirm they are the same on the front and back portions (for height and width). One such collectible might be read as 182, 2451, 5353 which could indicate that the depth of the cavity is 182 thousandths of an inch, the width is 2451 thousandths of an inch, and the height is 5353 thousandths of an inch. Thus, the numbers on the back portion might generally be referred to as DDD WWWW HHHH as depth, width, and height while the front portion might only have WWWW and HHHH.

In addition to potentially confirming for an assembler that the proper front and back portions were utilized for a given case based on the matching and legibility of the WWWW and HHHH numbers, the numbers may also be utilized as part of an automated image recognition process (e.g., machine learning) to accomplish one or more features.

An automated image recognition system, for example, might be able to automatically confirm that a specific collectible was placed in the correct sized case based on reading the numbers and comparing them to the collectible in the current sequence. In addition, the use of specific different back portions may have different costs associated with them based on the thickness and the complexity necessary to accommodate the varying thickness. In some instances, for example, it might be necessary to utilize different back cases due to availability for the same collectible. If three matching collectibles required a specific case but only two back portions of that size were available, the system might select a step-up in size for the third collectible to ensure the collectible is secured.

While the description above has included dimensions such as height and width, persons skilled in the art will appreciate that other shaped cases might include different dimensions, such as a hockey puck that might require a round case in which the diameter or radius of the case might be shown in place of the height and width.

The cases themselves might be made using a variety of processes, such as injection molding, thermoforming, adhesive affixing the two portions together, etc. In addition, the encapsulated cases may also include various members within the case such as rails or ribs that maintain the collectible in the proper location and orientation, as well as troughs on the opposing portion to accommodate and accept the rails/ribs to further ensure that the collectible is protected and properly displayed within the case.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is a three-dimensional view of an assembled case constructed in accordance with the principles of the present invention;

FIG. 2 is another three-dimensional view of an assembled case constructed in accordance with the principles of the present invention;

FIG. 3 is another three-dimensional view of an assembled case constructed in accordance with the principles of the present invention;

FIG. 4 is a side view of an assembled case constructed in accordance with the principles of the present invention;

FIG. 5 is a front view of an assembled case constructed in accordance with the principles of the present invention;

FIGS. 6 is a different side view of an assembled case constructed in accordance with the principles of the present invention;

FIGS. 7 is a rear view of a case constructed in accordance with the principles of the present invention;

FIGS. 8 is top view of a case constructed in accordance with the principles of the present invention;

FIGS. 9 is bottom view of a case constructed in accordance with the principles of the present invention;

FIGS. 10 are views of case markings constructed in accordance with the principles of the present invention;

FIGS. 11 are flow charts constructed in accordance with the principles of the present invention; and

FIGS. 12 are flow charts constructed in accordance with the principles of the present invention.

### DETAILED DESCRIPTION OF THE INVENTION

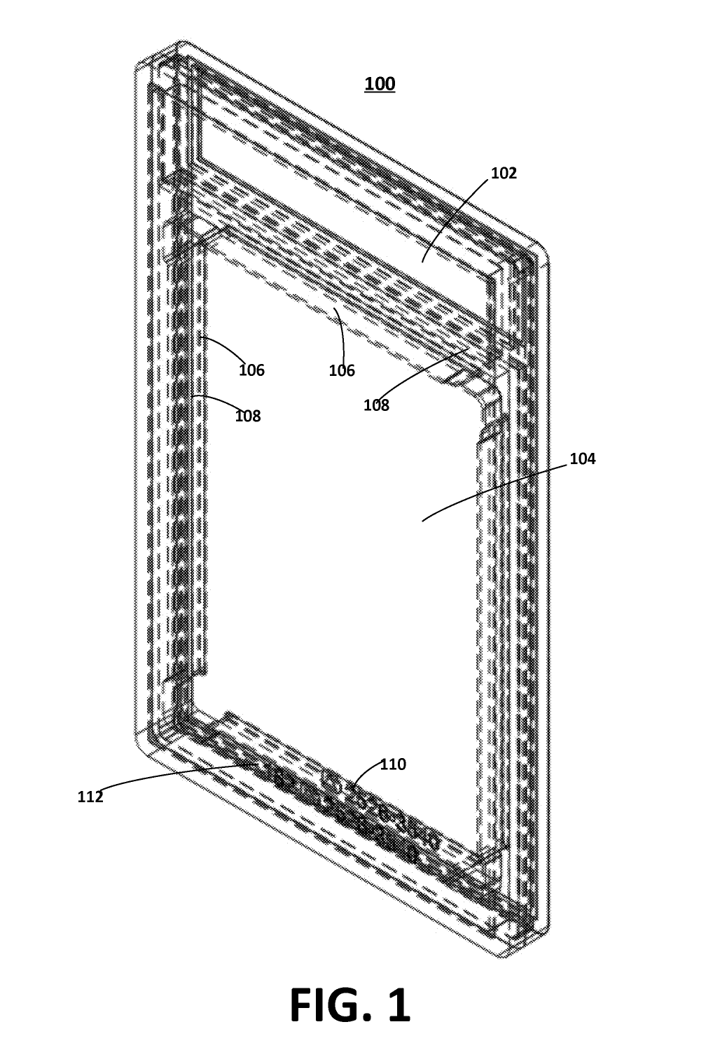

FIGS. 1-9 show various views of an assembled case in accordance with the principles of the present invention. FIG. 1 shows assembly 100 as a three-dimensional view of an assembled case containing two cavity portions 102 and 104. Cavity portion 102 may be utilized to contain a placard that might describe the collectible contained therein, the company that graded and/or encapsulated the collectible, a common, unique, or combination serial number that can be utilized to identify the collectible, a QR code or other scannable symbol, etc. Cavity portion 104 would be the region to contain the collectible.

Case 100 may also include a series of rails or ribs 106 that may operate to maintain the collectible in the proper location within cavity 104 during the encapsulation process and potentially after. Rails or ribs 106 may be located on the back portion of assembly 100 while troughs 108 may be included on the front portion of assembly 100 to accommodate the ribs in a manner that minimizes the potential movement of the collectible within cavity 104.

Also included in case 100 are a series of numbers 110 that may be located on the front portion of case 100. Those numbers might, as described above, be indicative of the height and width of cavity 104 but may be utilized with a number of different back portions each providing a different depth but having the same height and width. The rear portion may include a different series of numbers 112 in that an additional number which is indicative of the depth of cavity 104 is provided.

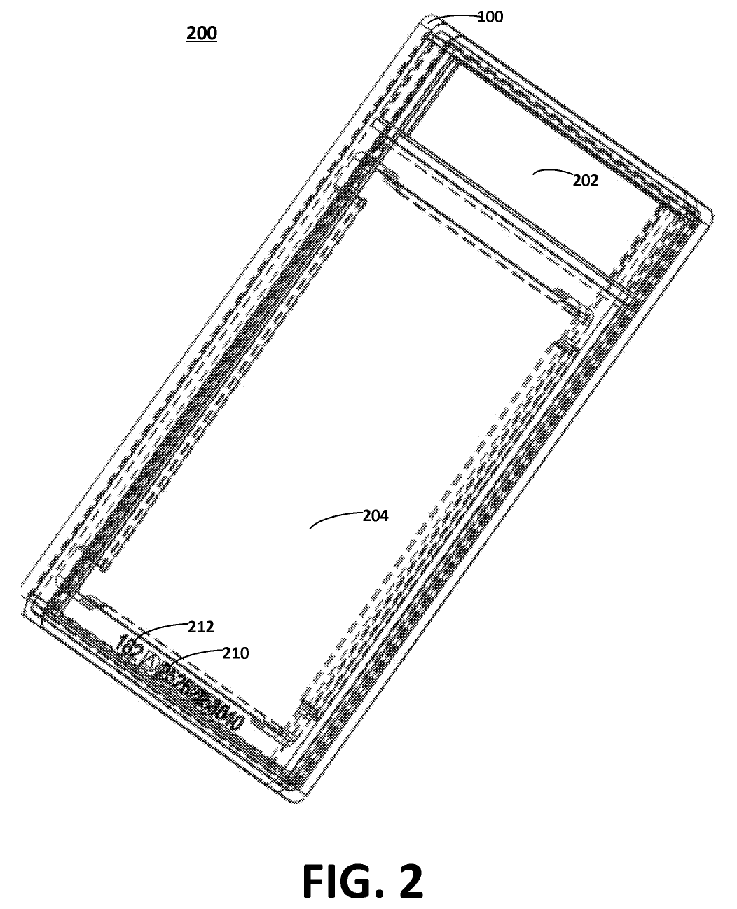

FIG. 2 shows the same case 100 in a different orientation 200 in which cavity 202 is the placard cavity described above with respect to 102 and cavity 204 is the collectible cavity described above with respect to 104. The different orientation shown by case 200 provides a more legible view of numbers 210 that appear on the front portion of case 200 as well as numbers 212 that appear on the back portion of case 200.

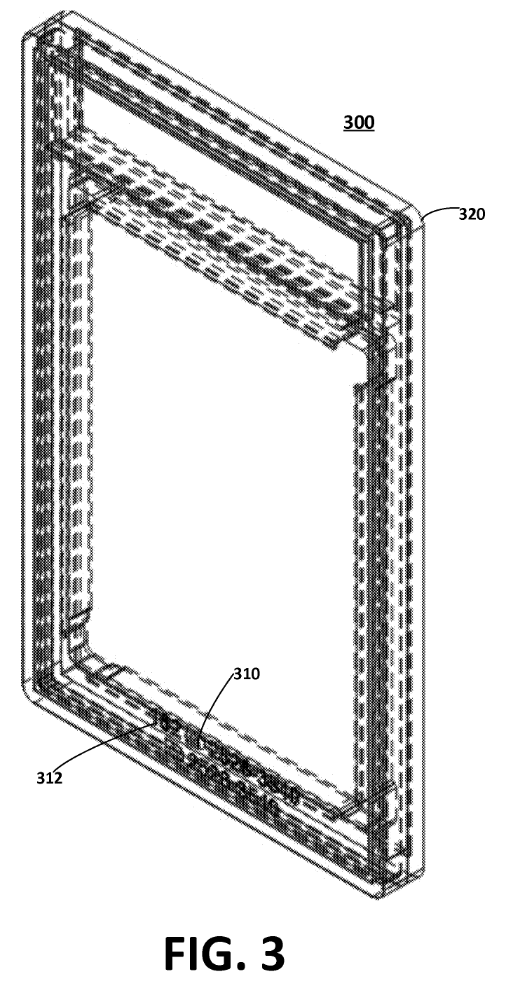

FIG. 3 shows case 100 in a different orientation as case 300. Case 300 provides a further clarified view of the numbers provided in the front and back portions of case 300. In particular, it should be readily apparent that only two numbers representing the height and width of case 300 are shown as numbers 310 on the front portion of case 300, while three numbers 312 representing the depth of the cavity, the height and width are provided on the rear portion of case 300.

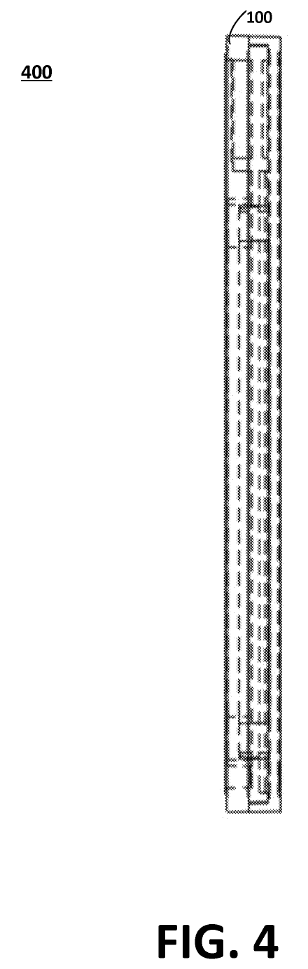

FIG. 4 provides a side view 400 of case 100.

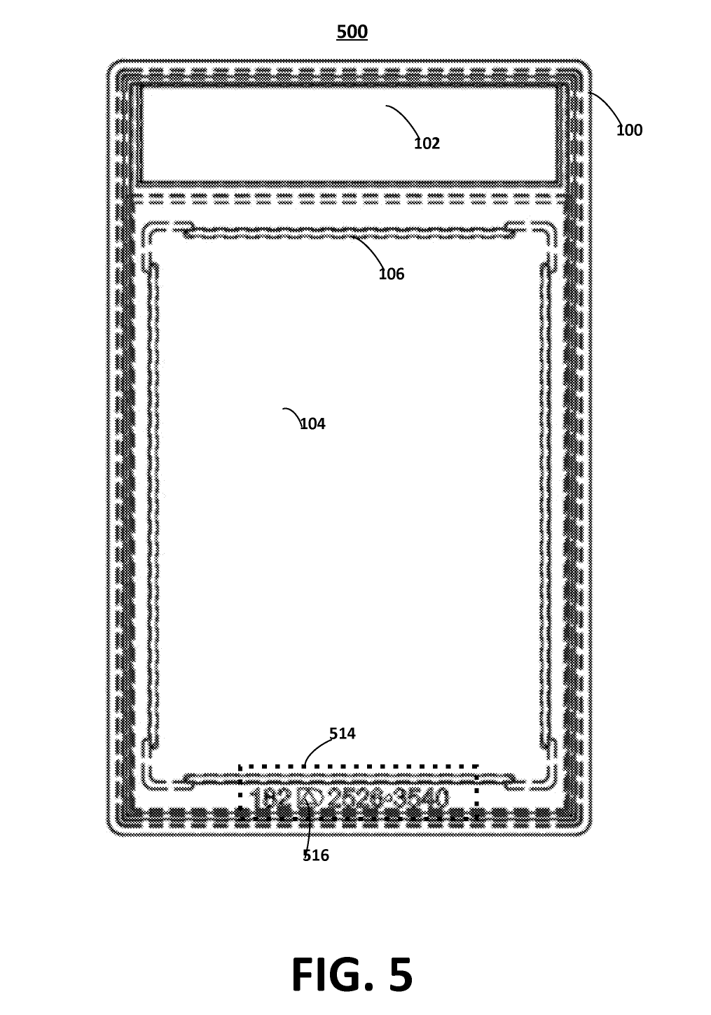

FIG. 5 provides a front view 500 of case 100 which illustrates various aspects of the present invention. View 500 of case 100 shows placard cavity 102 and collectible cavity 104 as well as rails or ribs 106 that maintain the collectible in its proper location. In addition, as described above, dimensional information 514 may be viewed in a manner that indicates that case 100 was properly assembled. If case 100 was not properly assembled such as, for example, if the dimensions of the front and back portions did not that, the numerals in information 514 would not be readily discernible. In this case, it would be readily discernible that the depth of cavity 104 is 182 thousandths of an inch, the width of cavity 104 is 2526 thousandths of an inch, and the height of cavity 104 is 3540 thousandths of an inch. In addition, a logo 516 of the company that performed the encapsulation is displayed.

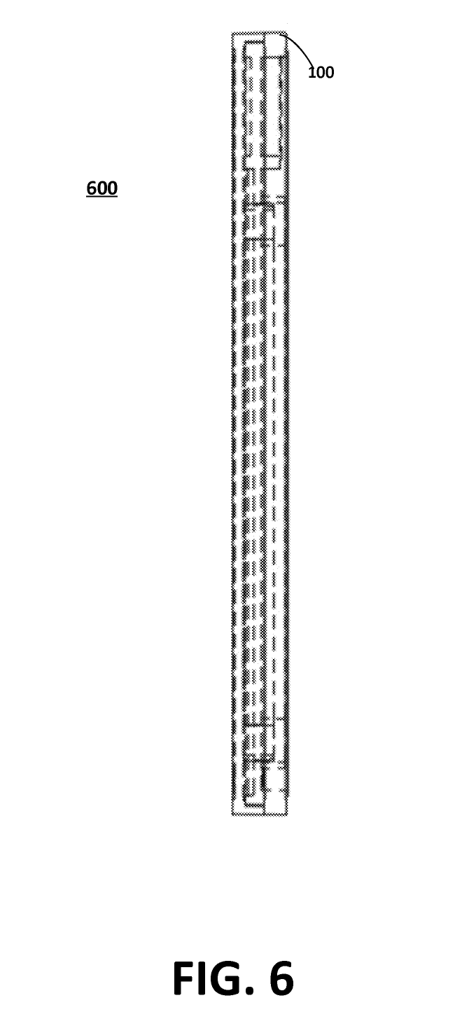

FIG. 6 shows side view 600 of case 100 which shows the side opposite that shown in FIG. 4.

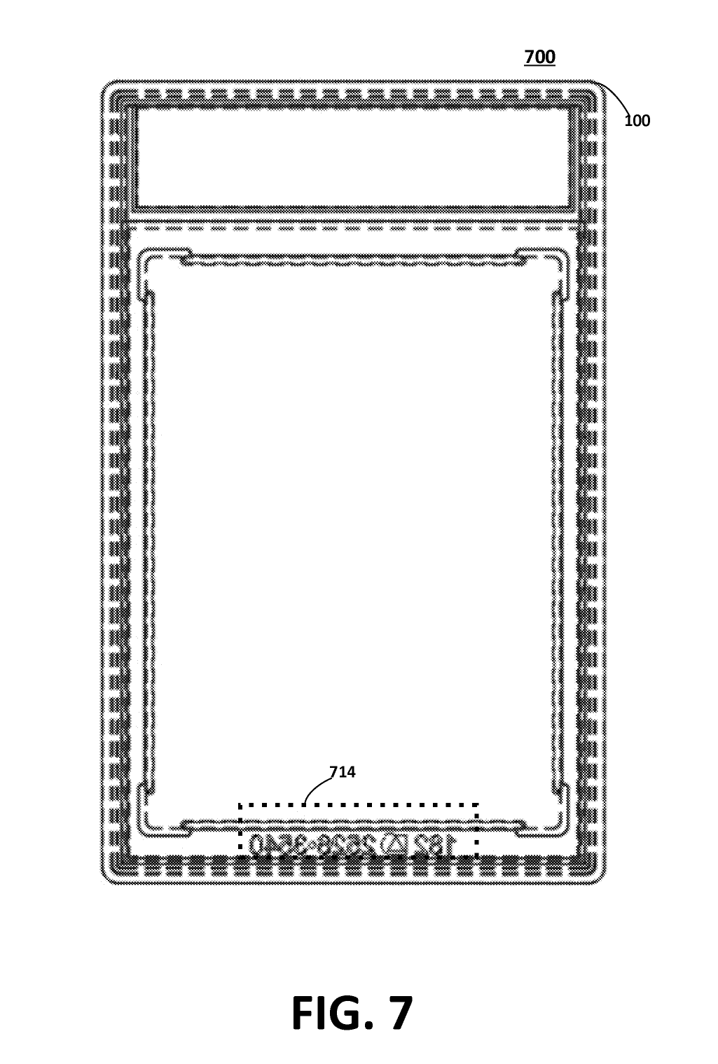

FIG. 7 shows back view 700 of case 100 which illustrates again a properly assembled case in that all of the numbers in information section 714 are readily discernible.

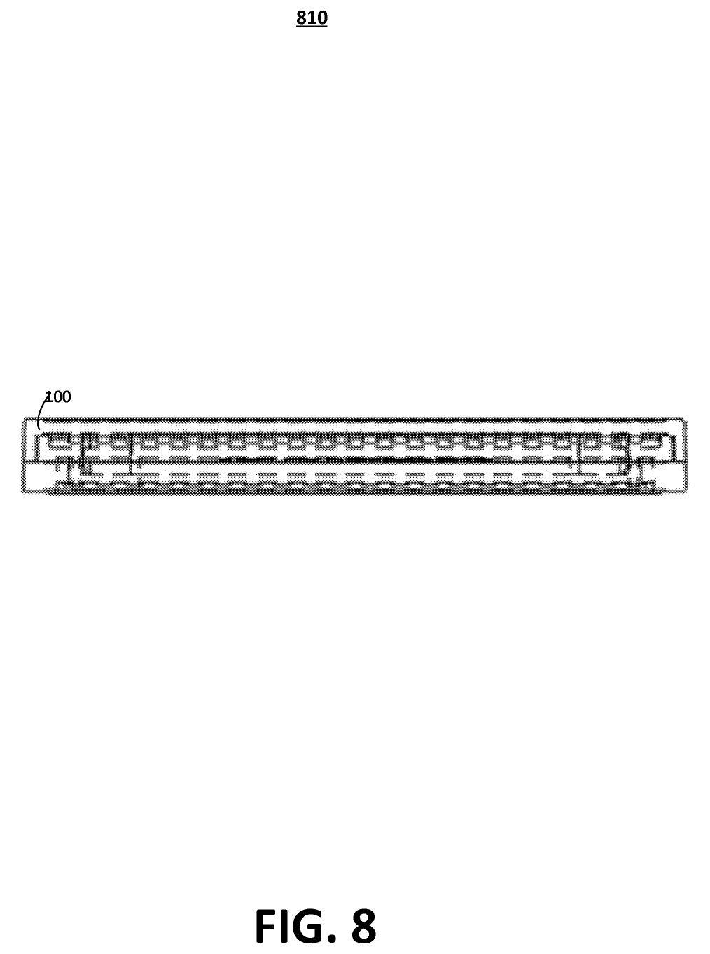

FIG. 8 shows a top view of case 100.

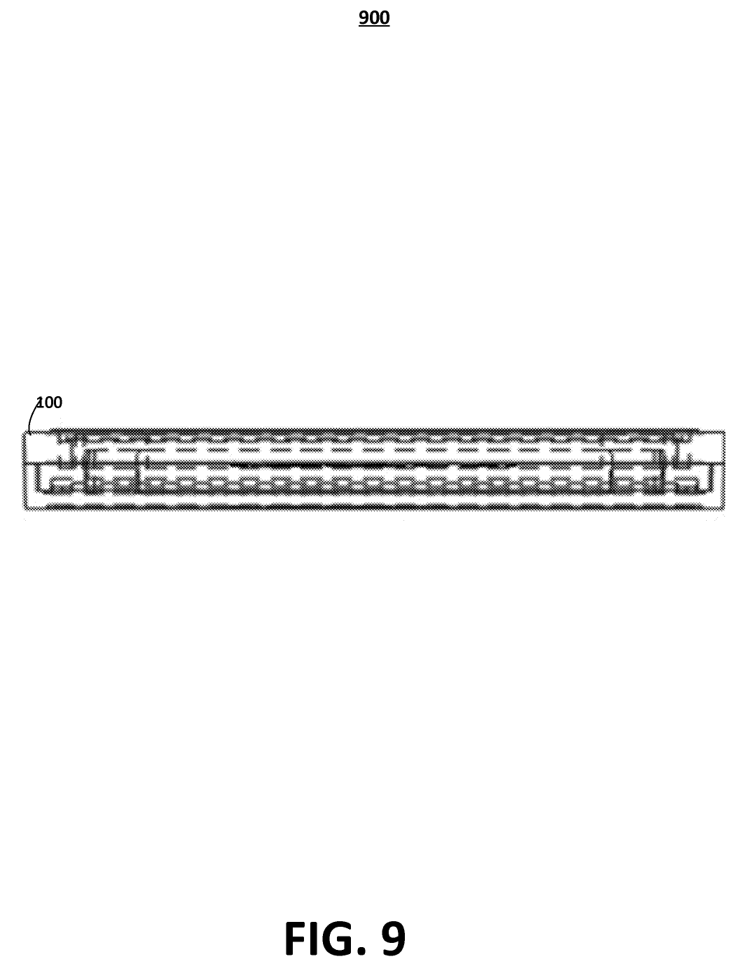

FIG. 9 shows a bottom view of case 100.

As noted above, case 100 of FIGS. 1-9 may be utilized in an automated image recognition process (e.g., machine learning) to perform a number of features. For example, the front and the back numbers may be captured to make sure the right case portions were used for an item and/or with respect to one another. Additionally, each individual instance of an item may be assigned a different cost. Suppose there are three instances of a 2025 Joe Smith trading cards. Suppose only two of an ideal case are available. An operator may encapsulate two of those items with the ideal cases and use the next preferred case size for the third item. The cases may then be imaged and the indicia utilized to provide item specific encapsulation costing, pricing, or any other activity.

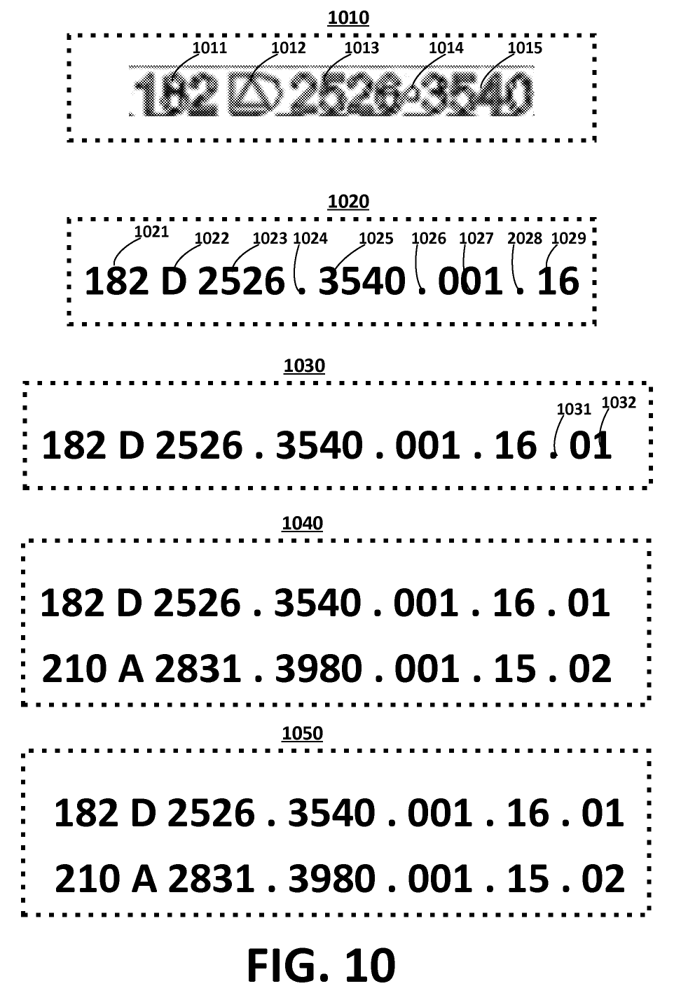

FIG. 10 shows case markings 1010 which may be, for example formed as part of an injection molding process for fabricating cases for permanently encasing items. Persons skilled in the art will appreciate that such encapsulation cases may be fabricated from any polymer such as a polystyrene, acrylic, SAN, polycarbonate, or any other type of polymer. Such polycarbonate may have a tougher melt (e.g., 2 to 3 melt, 3 to 4 melt, 4 to 5melt) in order to provide a harder surface so that, for example the surface may have improved scratch resistance. The polycarbonate may be any color such as, for example, a transparent color such as a water clear polycarbonate. A case may have any number of parts such as two parts, three parts, four parts, or more than four parts. The parts may be permanently fixed together though, for example, adhesive or welding (e.g., ultrasonic welding) or any type of process. Items provided inside an encapsulation case may include, for example, a collectible such as a trading card, trading card game card, comic book, action figure, handbag, shoes, memorabilia print, coin, stamp, watch, poster, figurine, toy, or any type of item). Multiple cavities may be provided in a case such as a cavity for an item and a cavity for a security tag (e.g., a tag with a QR code linking to a site showing pictures of the encased item, a unique identification number, a description of the item, a grade of an item, a grade of an autograph on an item, a grade for multiple autographs on an item, an RFID that can be used to determine the RFID is associated with the item encased, or any other object.

Cases may be injection molded in molds and such molds may fabricate 1 part, 2 parts, 4 parts, 8 parts, 12 parts, 16 parts, 18 parts, 24 parts, 36 parts, or any number of parts. A mold may have parts for different cases such that multiple different types of cases are manufactured at once by an injection molding device. The molds may have case markings so that a number of features and services may be performed using the case markings. A two-part case such as a trading card case may have a rear, or bottom, part that has a cavity to receive a trading card and a front, top part that can be ultrasonically sealed to the bottom part to form a cavity in which a trading card may be permanently stored. Trough’s may be provided on the obverse, front case portion in which rails extending from the reverse, rear case portion may fit into during ultrasonic welding so that no space exists for a trading card to escape the cavity.

Case markings may be added to an area of one or each portion of an encapsulation case and such markings may be placed in an area that does not overlap a side, multiple sides, all sides, of the encapsulated item (e.g., trading card or other collectible item) so that the item may be viewed unobstructed. Case markings may include different components such as the thickness of the cavity after encapsulation, the length of the cavity after encapsulation, the width of the cavity after encapsulation, the mold a part was manufactured in, a cavity the part was manufactured in, the exterior thickness of the encapsulation case (e.g., after ultrasonically sealing the case as the external dimensions of the case may different before and after the case was ultrasonically sealed together), the external length of the case, and the external width of a case.

Such encapsulation markings may be fabricated such when the case is sealed different case markings form a combined case marking that can be seen from one or more surfaces of the case (e.g., the front and the back surface of the case). Cases may be imaged with one or more cameras at one or more angles. For example, cases may be imaged in the front, rear, and at various degrees (e.g., plus and minus 5 degrees off the front and rear images) and may have angled cameras for (e.g., 45-degree cameras above and below an inline camera). Accordingly, for example, a trading card may have 2 pictures, 18 pictures, 36 pictures, of different angles of the encapsulation case with the trading card inside. In doing so, the individual part markings and the combined case markings may be seen in multiple images. A marking determination system may review the case and may determine the combined case markings. The identification information on a collectible’s tag in the encapsulation case may be read and the case that was supposed to be used can be retrieved from a remote system (e.g., a remote server and/or a remote database). The combined markings of the encapsulation case determined from image analysis may be compared to the retrieved case. If the cases are different, data may be updated (e.g., in a remote system) and/or a notification may be sent that an item was encapsulated with the wrong case and the action may be remediated.

Persons skilled in the art will appreciate that an item may fit into multiple cases and that different cases may have different costs to manufacture and may be billed at different rates to customers. An operator may utilize different cases depending on the supply of cases available for a manufacturing operation. Accordingly, an item may be encapsulated in a variety of encapsulation cases (e.g., a variety of approved encapsulation cases). Image analysis may occur to determine the encapsulation case used to determine the cost of goods sold and/or bill of materials for the case as well as the price to charge a customer. Reports may be generated per customer or for other uses that include the itemized cost of all of the cases in a work order, project, period of time, etc.

Persons skilled in the art will appreciate that one or more cases may be requested to ship to a customer. Image analysis may determine the combined markings to determine also the exterior dimension of the case utilized and to determine the box size needed to ship a particular group of cases and/or how many cases and what cases to put into a particular shipping container. The weight of each encapsulation case may be stored as well such that the weight of each case may be utilized to determine a weight for a case, group of cases, and/or packaging container with a group of cases. In doing so, an improved shipping price may be determined and provided to a customer at time of purchases that may better reflect the actual weight determined at time of shipping.

FIG. 10 shows combined case markings 1020 which may include markings 1011 on one portion (e.g., an obverse, front potion) that is ultrasonically sealed to a second portion (e.g., a reverse, back potion that may include markings 1012, 1013, 1014, and 1015. Ass shown in FIG. 10, the marking “182” may be, for example, the thickness of a cavity that houses a collectible item after sealing where the marking at reference numeral 1012 may be a mark representative if the manufacturer (e.g., the company making the cases), while the mark “2526” refers to the width of the cavity after sealing in thousandths of an inch, and the mark indicated by reference numeral 1014 may include a spacer marking to separate groups of numbers that form separate pieces of data (e.g., similar to an advantage of the placement of the mark at location 1012), while the mark “1015” may be representative of the length/height of a cavity after sealing.

Case 1020 may include a combination of markings indicated by reference numerals 1021-1029 with the mark at 1021 being on one portion of case 1020 and the marks at reference numerals 1022-1029 being on a second portion of case 1020. The marks shown by reference numerals 1021-1025 may be similar to, for example, the marks shown by reference numerals 1011-1015 of case 1010. Similarly, as previously described with reference to the mark at 1014, the marks at reference numerals 1026 and 1028 may be spacer markings to separate different groups of data. The mark at 1027 may refer to the mold number that was used to manufacture one or both portions of case 1020 and the mark at 1029 may refer to a cavity of that mold. Person skilled in the art will appreciate that at least the marks at 1027 and 1029 may be provided also on the first portion (front, obverse portion) and they may represent different items. As such, the front image may be utilized to determine the front markings (or markings on the front portion of case 1020) and the reverse image may be utilized to determine the reverse markings (or markings on the back portion of case 1020). Persons skilled in the art will appreciate that the marks may be placed anywhere on the case. For example, the mark at 1027 may be half the size shown in FIG. 10 and the marking on the back may be placed above the same mold number mark on the front portion. Accordingly, if the two marks are different numbers, one could have improved viewing of both the marks (e.g., the same vertical stacking of marks may be done for cavity marking 1029). Markings may be added for any type of data on any one or more slabs. For example, the marks at 1022, 1023, and/or 1025 may be provided on either portion of case 1020 or on both portions of case 1020.

The markings on case 1030 may include, for example, the numbers and letters shown in FIG. 10, which may, for example, include spacer marking 1031 and the marking at 1032. The marking at 1032 may be, for example, a revision number. Person skilled in the art will appreciate that molds may be revised, resurfaced, materially altered, receive material maintenance and a revision number may be provided based on the revision of that cavity in that mold. In doing so, the different revisions of a cavity of a mold may be tracked.

Case 1040 may include two rows of markings. The first row may, for example, includes the same markings as shown on case 1030. The second or bottom row may, for example, include any number of markings associated with the external dimensions (e.g., as previously described). These may include, for example, external thickness, width, length/height, mold number(s), cavity number(s), revision number(s) so that the external dimensions of an encapsulated case may be known in addition to the internal cavity size. Persons skilled in the art will appreciate that any or all markings of any portion of a case may be provided on one portion or multiple portions in any manner and that a portion or all of the markings may be duplicated on one or more case portions. Similarly, case 1050 may include one, two, or more rows of markings (two rows of markings are illustrated in FIG. 10 for case 1050). These markings may also be utilized to ensure, for example, proper fit between the front portion and the back portion, proper fit for a given collectible within the cavity size indicated by the markings based on the type of collectible at issue, internal and/or external dimensions, etc.

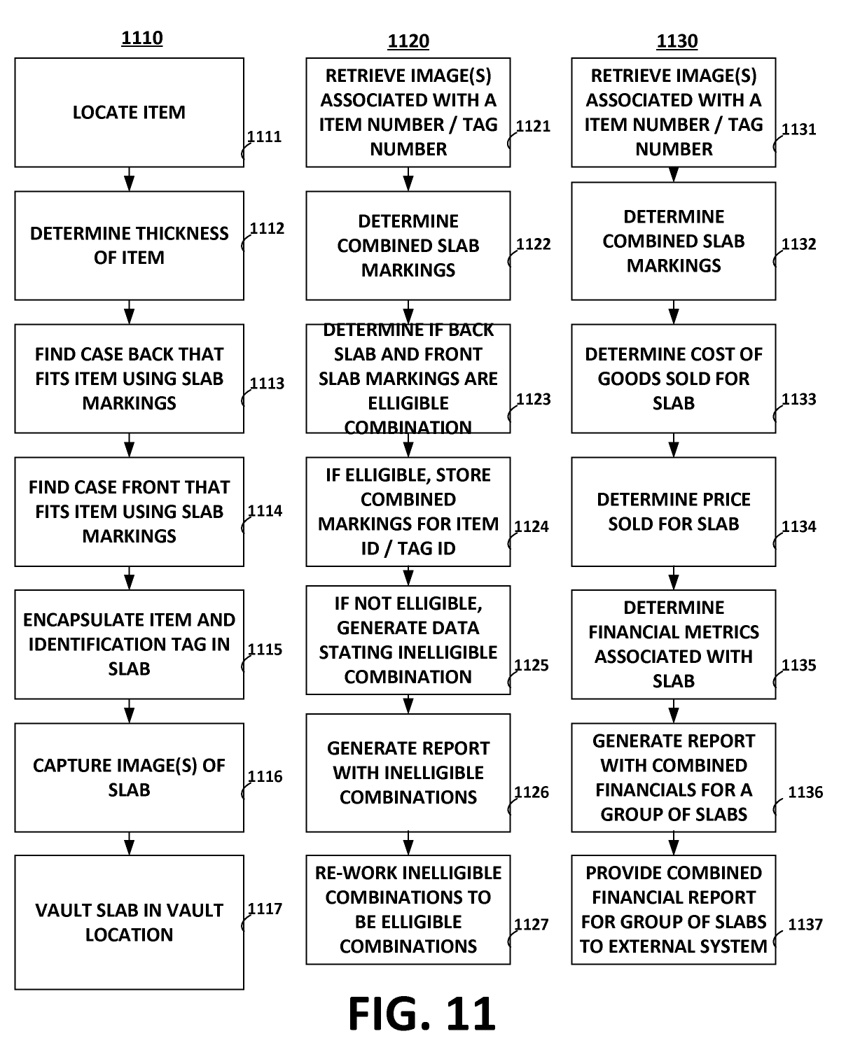

FIG. 11 shows several flow charts 1110, 1120, and 1130. Flow chart 1110 in which step 1111 is provided where an item is located (the item may be, for example, a collectible, such as a trading card, comic, book, or even a three-dimensional item such as a baseball or hockey puck). Step 1112 may occur in which a thickness of the item may be determined. Such a thickness may be retrieved from data storage that provides thicknesses of various items. The case back portions for encapsulating the item may be identified in step 1113 (e.g., associated with the thickness of the item that was retrieved and the thickness and length and width markings on the case). Person skilled in the art will appreciate that data storage (e.g., remote data storage may not only store the thickness of an item but all general dimensions such as length and width as well as the preferred case or suitable case as well as the associated case parts as well as the internal cavity dimensions and external cavity dimensions of that case, such as dimensions after encapsulation, as well as the weight of the case and cost(s) of the case). Step 1114 may be included in which the case front is found using the case markings. Person skilled in the art will appreciate that a case may have multiple portions (e.g., two) and that one portion may have a first set of physical structures and the other portion may have a second set of physical structures and these features may be changed so that the first case portion has the second set of structures and the first case portion has the first set of structures (the physical structures may, for example, prevent the item from moving within the cavity formed between the front and rear portions while protecting the item from damage). The item may be encapsulated in the case portions with a tag, such as an identification tag that identifies the item and includes a unique identification number or other unique identification such as a unique QR code, in step 1115. One or more images may be captured of the encapsulated item in step 1116. The encapsulated item may be vaulted and associated in data storage may be a vault location so the item may be easily and potentially automatically retrieved at a later point (e.g., during a shipping process and/or remediation process and/or upgrade process such as a grading process).

FIG. 11 also shows flow chart 1120 that may include step 1121 in which one or more images are retrieved showing the encapsulated item with the tag that are associated with a unique tag number for the item. Step 1122 may be utilized to determine from the images the combined slab markings for that tag number (e.g., the markings on each case portion). A determination may be provided in step 1123 if the case markings are appropriate for the associated item. If the combination is appropriate, then the combined slab markings or any portion of the case markings may be stored (e.g., in a remote server). If the combination is not an eligible markings combination for that item, an ineligible combination status may be determined in step 1125 and data may be stored indicating that status (e.g., a report) stating the combination is ineligible for the item. A report of ineligible combinations may be generated in step 1126. Remediation may then be requested in step 1127 (e.g., the case may be broken, the item removed, and the item re-encapsulated with new slab portions that provide a valid case combination for the item).

FIG. 11 also shows flow chart 1130 in which one or more images may be retrieved in step 1131 for one or more cases (e.g., one or more encapsulated items). The markings on one or more portions of a case such as the combined case markings may be determined in step 1132 utilizing an analysis of the retrieved image(s). The cost of the goods sold may be determined for the encapsulated item in step 1133 and the price to charge, or charged to, a customer may be determined in step 1134. Financial metrics (e.g., profitability, third party payments) may be determined in step 1135 (e.g., utilizing data from steps 1133 and 1134). A financial report of one or more cases may be generated in step 1136 and provided to an external system in step 1137 (e.g., a financial report of a product that includes a number of encapsulated items or encapsulated items associated with an owner and/or customer).

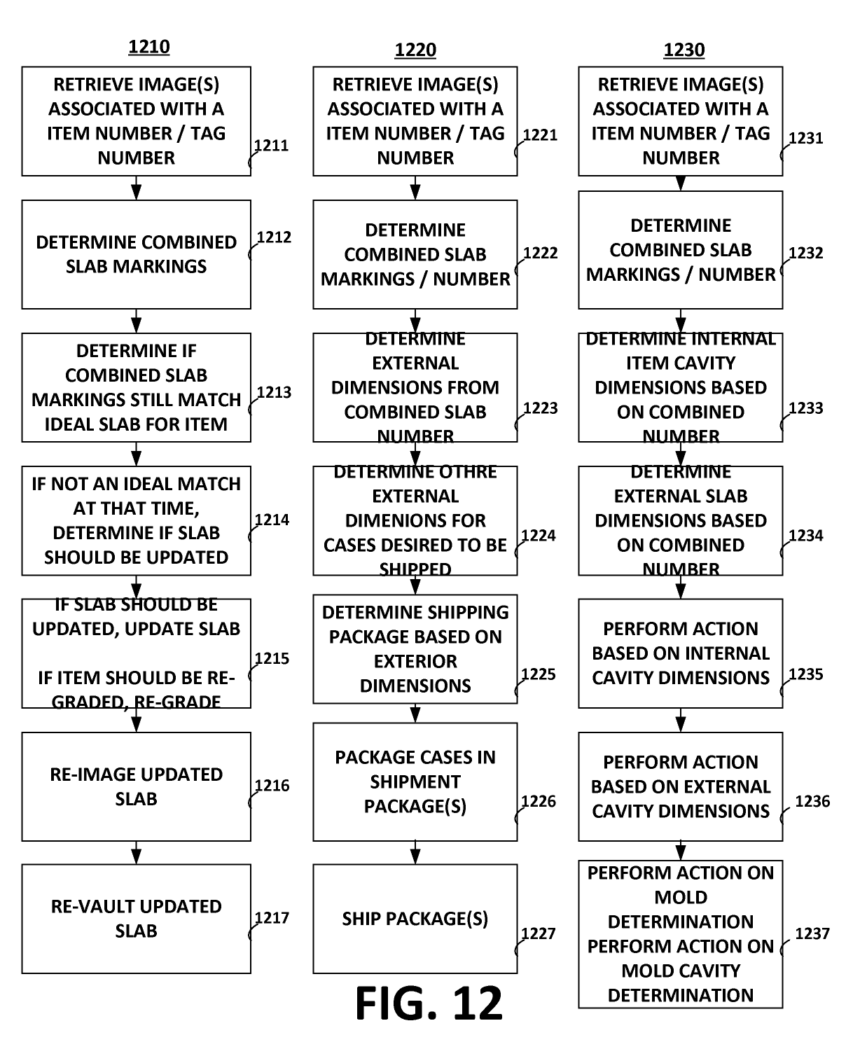

FIG. 12 shows flow charts 1210, 1220, and 1230. Flow chart 1210 includes step 1211 in which digital images are retrieved associated with a unique item number for an encapsulated item. In step 1212, the case markings are determined for a case utilizing at least one of the retrieved images. Person skilled in the art will appreciate that case markings may also be stored the first time images are utilized to identify case markings and those stored case markings can be retrieved. Case markings can also be manually entered (e.g., by entering a part number and/or an assembly number for an encapsulation case) when the item is encapsulated and the markings associated with a unique item identification number. An ideal, or proffered slab, may be stored for a particular type of item (e.g., a particular thickness and dimensioned trading card) and the markings may be compared against the preferred slab for that item dimensions (or a ranged of preferred cases). Person skilled in the art will appreciate that new cases may be designed and manufactured at any time so that a preferred case may change over time. An 80pt card may have a preferred case of 90pt until an 85pt case is designed and manufactured. If not an ideal case, a determination may be made (e.g., by retrieving data associated with the situation) to determine if the encapsulation case should be updated. Persons skilled in the art may appreciate that encapsulation case may be desired to be updated for a number of reasons such as, for example, compromised security or later determined imperfections in the encapsulation case. Step 1213 determines if the combined slab portions markings match the ideal slab for the item. Step 1214 determines if a slab should be updated due to a not ideal match. Step 1215 determines how to update the slab if a not ideal match was made and also determines whether to regrade the item. When a case is updated, the updated case may be re-imaged in step 1216 and re-vaulted in step 1217.

FIG. 12 also shows flow chart 1220 in which images may be retrieved associated with a unique item identification number in step 1221 and the markings associated with the case in the images retrieved may be determined in step 1222 and external dimensions of the case may be determined in step 1223. Persons skilled in the art will appreciate that images may also be able to determine cavity dimensions, item dimensions, external dimensions, and any type of dimensions without case markings. For example, a ruler may be included in an image (e.g., a tag having a known set of dimensions) and the dimensions of items in the picture may be determined using that known dimensioned reference. A group of cases may have their external dimensions gathered in step 1224 and a shipping package (or packages) may be determined based on those external dimensions as well as how to organize the cases in a shipping package for a goal (e.g., density, cost, shipping safety, etc.). The cases can be packaged according to the determined packaging profile/instructions determined in step 1225 and packaged in step 1226. The packages are then shipped in step 1227

FIG. 12 also shows flow chart 1230 that may include step 1231 in which a unique tag number is utilized to retrieve one or more images associated with the tag. Case markings, or case information using any process herein, may be determined in step 1232. The internal item cavity dimensions may be determined in step 1233. The external dimensions may be determined in step 1234. Actions may be performed on internal cavity dimensions in step 1235 (e.g., preferred case comparison) and actions may be determined based on external case dimensions in step 1236 (e.g., shipping instructions) and actions may be performed based on mold and/or mold cavity determinations as well as mold revision determinations (e.g., an imperfection is in a particular mold or a particular cavity or a particular revision). Such actions may include the initiation of processes such as re-slabbing processes, shipping processes, re-grading processes, or any other processes to perform action on the mold and or mold cavity based on the determination in step 1237.

Persons skilled in the art will also appreciate that the present invention is not limited to only the embodiments described. Instead, the present invention more generally involves dynamic information. Persons skilled in the art will also appreciate that the apparatus of the present invention may be implemented in other ways then those described herein. All such modifications are within the scope of the present invention, which is limited only by the claims that follow.

What is claimed is:

1. A permanently sealed encapsulation case comprising:
a first polymer case portion and a second polymer case portion permanently fixed together to form a cavity sized and shaped to encapsulate an item; and
indicia permanently formed on at least one of said first polymer case portion or the second polymer case portion, wherein said indicia comprises numerical information representing internal dimensions of said cavity including at least one dimension selected from height, length, and width;
wherein, upon permanent fixation of said first and second polymer case portions, said indicia on each case portion align to form a visually continuous numeric marking indicating at least a length or width dimension of said cavity.

2. A system including:
a processor for retrieving images of an encapsulated collectible and determining encapsulation dimensional information from the retrieved images for an encapsulated collectible and for utilizing said encapsulation dimensional information to determine shipping instructions based on said encapsulation dimensional information.

3. An encapsulation case comprising:
a first portion; and
a second portion, wherein said first portion is operable to be ultrasonically sealed to said second portion to permanently encapsulate a collectible item in a cavity formed in between said first and second portion, wherein a thickness dimensional mark is formed in said first portion associated with a thickness of said cavity, a width dimensional mark is formed in said second portion associated with a width of said cavity, and a length of said dimensional mark is formed in said second portion associated with a length of said cavity.

4. A system including:
a processor for retrieving one or more images associated with an encapsulated collectible item and operable to determine from said one or more images a cavity thickness marking, a cavity length marking, and a cavity width marking of said encapsulated case and utilizing said cavity thickness marking, cavity length marking, and cavity width marking as part of a subsequent process.
